(19) United States
(12) Patent Application Publication
(10) Pub. No.: US 2004/0163501 A1
(43) Pub. Date: Aug. 26, 2004

(54) Tool handle

(76) Inventor: Kun-Chen Chen, Taichung Hsien (TW)

Correspondence Address: VARNDELL & VARNDELL, PLLC, 106-A S. COLUMBUS ST., ALEXANDRIA, VA, 22314, US

(21) Appl. No.: 10/369,773

(22) Filed: Feb. 21, 2003

(51) Int. Cl. B25B 23/16

(52) U.S. Cl. 81/177.1

(57) ABSTRACT

A tool handle in accordance with the present invention elementally consists of a cylinder with two ends. A tool handle has a hexagonal axial socket defined in one end of the cylinder and a second hexagonal radial socket defined near the other end of the cylinder perpendicular to the hexagonal axial socket. Thereby, a tool handle can selectively engage a tool head at the hexagonal axial socket or the hexagonal radial socket to drive the tool head in different ways.

### BACKGROUND OF THE INVENTION

1. Field of the Invention

The present invention relates to a tool handle, and more particularly to a tool handle adapted to connect selectively to a tool head with a hexagonal connector at a front end or a rear end of the handle.

2. Description of Related Art

With reference to FIG. 7, a conventional tool handle (50) is a short cylinder with a curved outer surface and has a front end (51), a rear end (52), and a front face (not numbered) formed on the front end (51). A hexagonal socket (511) is defined in the front face and adapted to receive a hexagonal connector (not numbered) of a tool head (60). A through hole (521) is defined transversally in the rear end (52).

When the conventional tool handle (50) is used, the tool head (60) attaches to the tool handle (50) by inserting the hexagonal connector into the socket (511) in the tool handle (50). The hexagonal connector does not rotate in the inserting hole (511) because the hexagonal shape of the connector and the socket (511) keep the connector from rotating in the socket so the tool handle (50) drives the tool head (60). However, when heavy resistance is applied to the tool head (60), turning the tool head (60) by simply gripping the cylindrical tool handle (50) may be virtually impossible. Therefore, a crossbar (70) with two ends is inserted through the through hole (521) so the two ends are on opposite sides of the tool handle (50). When a person grips the ends of the crossbar (70), the crossbar (70) provides a significantly larger torque force on the tool handle (50) to rotate the tool head (60).

As described, the crossbar (70) is an extra but often essential element of the tool handle (50). If the crossbar (70) is lost, finding a replacement for the crossbar (70) for the tool handle (50) may be very difficult so that the tool handle (50) cannot be used where a large torque force is required.

The present invention has arisen to mitigate or obviate the disadvantages of the conventional tool handle.

### SUMMARY OF THE INVENTION

The main objective of the present invention is to provide a tool handle that can be used directly to generate a large torque force without other auxiliary elements.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a tool handle in accordance with the present invention;

FIG. 2 is an operational exploded perspective view of the tool handle in FIG. 1 with a socket head attached at the front end of the handle;

FIG. 3 is an operational perspective view of the tool handle in FIG. 1 with the socket head attached at the rear end of the handle;

FIG. 4 is an enlarged side plan view in partial section of the tool handle along line 4-4 in FIG. 3;

FIG. 5 is an operational exploded perspective view of the tool handle in FIG. 1 with a screwdriver head attached at the front end of the handle;

FIG. 6 is an operational exploded perspective view of the tool handle in FIG. 1 with the screwdriver head attached at the rear end of the handle; and

FIG. 7 is a perspective view of a conventional tool handle in accordance with the prior art.

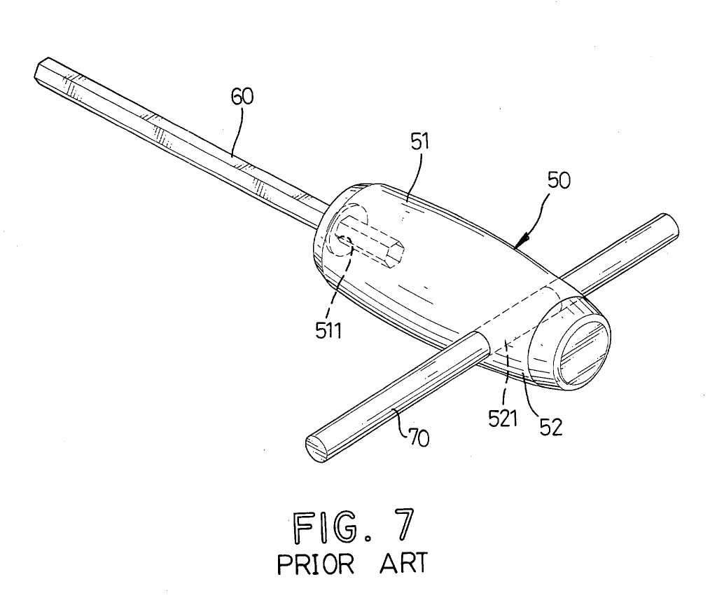

### DETAILED DESCRIPTION OF THE PREFERRED EMBODIMENT

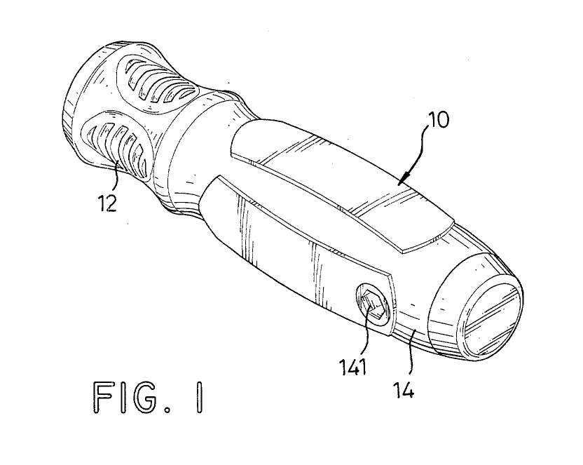

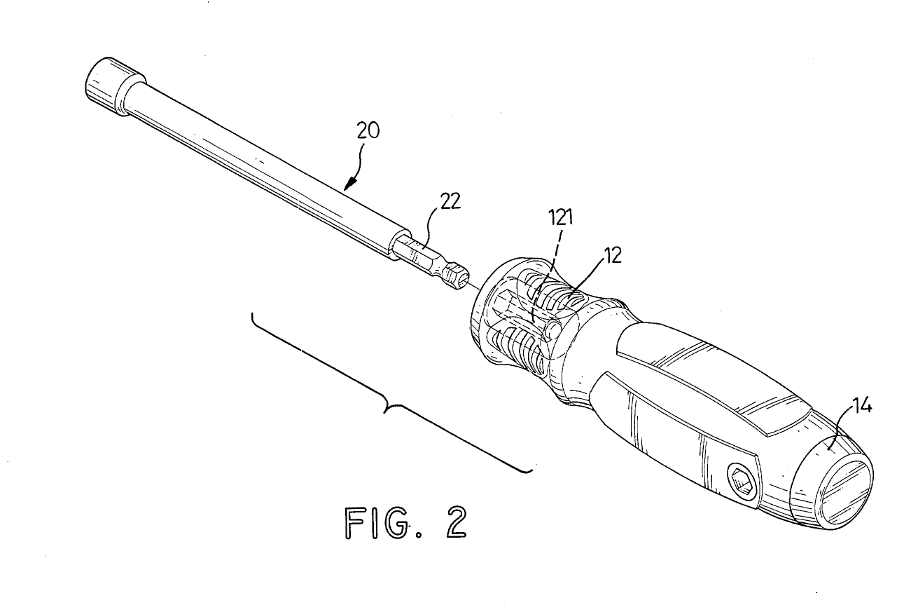

With reference to FIGS. 1 and 2, a tool handle in accordance with the present invention is a cylinder (not numbered) with a front end (12), a rear end (14) and a flat front face (not shown). The flat front face (not shown) is formed at the front end (12) of the tool handle. The tool handle comprises a hexagonal axial socket (121) and a hexagonal radial socket (141) formed in the cylinder. The hexagonal axial socket (121) is defined axially in flat front face of the front end (12) of the cylinder and adapted to engage a hexagonal connector (22) on a socket head (20). A neck (not numbered) is defined around the connector (22) to mate with a ball-spring holder. Additionally, a metallic hexagonal sleeve (not numbered) corresponding to the hexagonal axial socket (121) is securely mounted inside the hexagonal axial socket (121) to keep the periphery of the hexagonal axial socket (121) from breaking. A magnet (not numbered) is attached inside the metal hexagonal sleeve to provide a retaining force on the tool socket head (20) that is made of metal. The hexagonal radial socket (141) is defined radially at the rear end (14) of the cylinder perpendicular to the hexagonal axial socket.

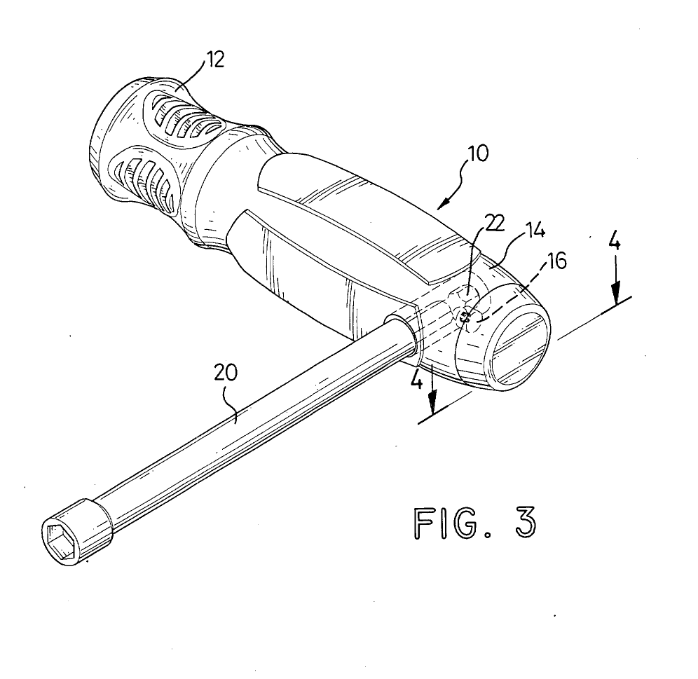

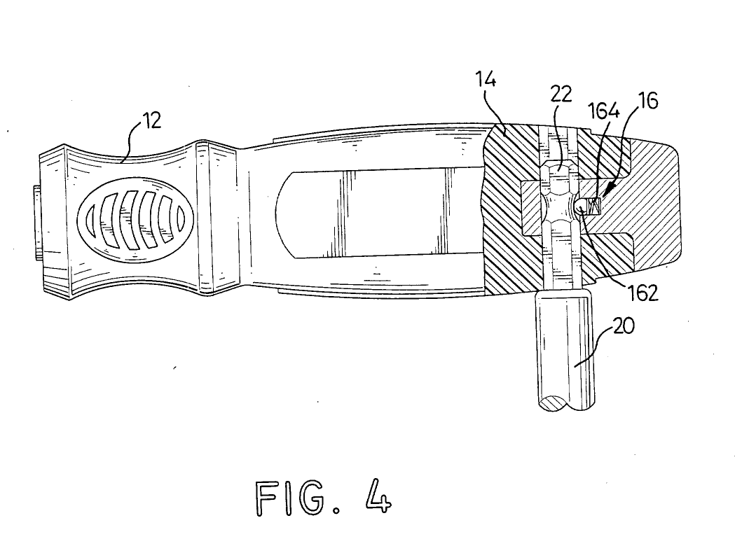

With further reference to FIGS. 3 and 4, a retaining device (16) is mounted inside the hexagonal radial socket (14) to keep the hexagonal connector (22) from sliding out of the hexagonal radial socket (141). The retaining device (16) comprises a ball (162) and a resilient element (164). The resilient element (164) abuts and presses the ball (162) and causes the ball (162) to protrude into the hexagonal radial socket (141). When the connector (22) of the tool head (20) is pressed into the hexagonal radial socket (141), the hexagonal shape keeps the connector (14) from rotating inside the hexagonal radial socket (141). Furthermore, the ball (162) is pushed into and held in the neck of the connector (22) by the resilient element (164). The resilient element (164) is a spring and provides a resilient force on the ball (162) to hold the connector (22). Thereby, the connector (22) of the tool head (20) can be selectively attached to the handle (10) by the ball (162) or detached from the handle (10) by applying a tensile force on the tool head (20).

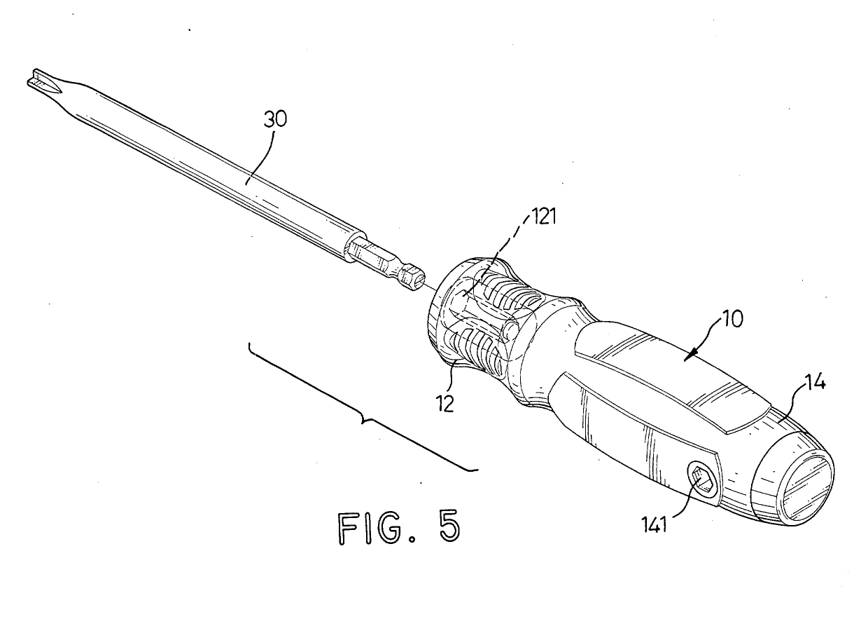

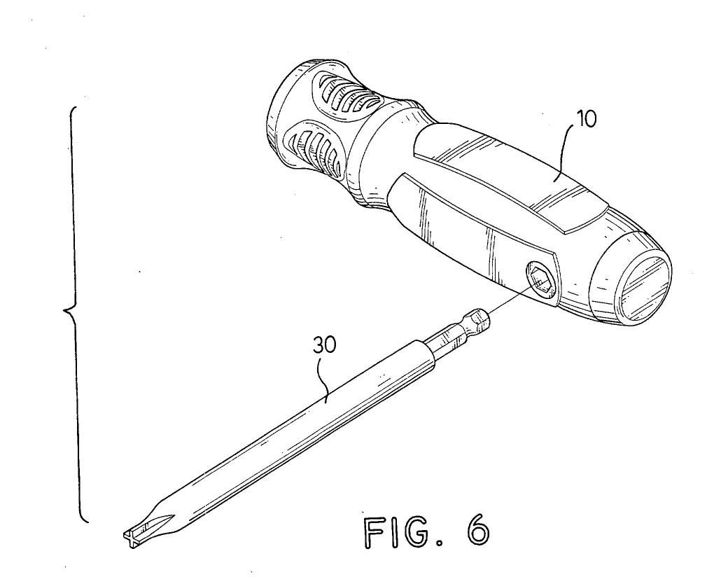

With reference to FIGS. 5 and 6, the tool handle (10) is adapted to engage the connector (not numbered) of a screw driver head (30). When the tool handle (10) is used, the screwdriver head (30) can be selectively attached to the hexagonal axial socket (121) or the hexagonal radial socket (141). When the screwdriver head (30) engages the hexagonal axial socket (121), the tool handle (10) is axially rotated to drive the screw driver head (30). Additionally, when the screwdriver head (30) engages the hexagonal radial socket (141), the tool handle (10) forms a grip perpendicular to the screwdriver head (30). Therefore, the tool handle (30) can be rotated with more torque force to easily drive the screw driver head (30).

According to foregoing description, the tool handle can provide a large torque force to the tool head without other additional auxiliary elements, so a person does not have to worry about losing any auxiliary elements.

Although the invention has been explained in relation to its preferred embodiment, it is to be understood that many other possible modifications and variations can be made without departing from the spirit and scope of the invention as hereinafter claimed.

What is claimed is:

1. A tool handle comprising:
a cylinder with a front end (12) and a rear end (14);
a hexagonal axial socket (121) defined in the front end (12) of the cylinder;
a hexagonal radial socket (141) defined near the rear (14) end of the cylinder perpendicular to the hexagonal axial socket (121); and
a retaining device (16) mounted inside the hexagonal radial socket (141).

2. The tool handle as claimed in claim 1, wherein the cylinder has a flat front face formed at the front end (12).

3. The tool handle as claimed in claim 2, wherein the hexagonal axial socket (121) is axially defined in the front face at the front end (12).

4. The tool handle as claimed in claim 1, in which a metallic hexagonal sleeve corresponding to the hexagonal axial socket (121) is secured inside the hexagonal axial socket (121); and
a magnet is attached inside the metallic hexagonal sleeve.

5. The tool handle as claimed in claim 3, in which a metallic hexagonal sleeve corresponding to the hexagonal axial socket (12) is secured inside the hexagonal axial socket (121); and
a magnet is attached inside the metallic hexagonal sleeve.

6. The tool handle as claimed in claim 1, wherein the retaining device (16) comprises a ball (162) and a resilient element (164) abutting to the ball (162).

7. The tool handle as claimed in claim 3, wherein the retaining device (16) comprises a ball (162) and a resilient element (164) abutting to the ball (162).

8. The tool handle as claimed in claim 5, wherein the retaining device (16) comprises a ball (162) and a resilient element (164) abutting to the ball (162).
